(19) United States
(12) Patent Application Publication
(10) Pub. No.: US 2006/0161660 A1
(43) Pub. Date: Jul. 20, 2006

(54) Method for automatic browsing in interposition mode

(76) Inventors: Sebastien Brault, Caen (FR); Benoit Bailleux, Cormelles Le Royal (FR); Jerome Laforge, Mondeville (FR)

Correspondence Address: YOUNG & THOMPSON, 745 SOUTH 23RD STREET, 2ND FLOOR, ARLINGTON, VA, 22202, US

(21) Appl. No.: 11/328,129

(22) Filed: Jan. 10, 2006

(30) Foreign Application Priority Data
Jan. 14, 2005 (FR) 05 00427

(51) Int. Cl. G06F 15/173

(52) U.S. Cl. 709/226

(57) ABSTRACT

The present invention relates to a method for automatic browsing from a web browser over a plurality of web pages which are stored on servers so that all the data flows between the browser and the servers of the web pages pass via an interposition server, including steps for: creating and storing at least one scenario for automatic browsing having a web page address for launching the scenario and at least one web page address for redirection, selecting the automatic browsing scenario including the launch address which corresponds to the address of a request transmitted by the web browser, intercepting the response of the host server to the request for access with the interposition server, modifying the response into a redirection response including the redirection address defined in the scenario, generating a request by the browser to access the redirection web page.

### FIELD OF THE INVENTION

The present invention relates to a method for automatic browsing from a web browser over a plurality of web pages which are stored on servers so that all the data flows between the browser and the servers of the web pages pass via an interposition server. It also relates to a server and a software product.

With the development of technologies relating to the internet network, a number of business data-processing applications are carried or interfaced on the internal internet network, or intranet, of the company. The use of applications of this type is carried out by means of browsing from page to page using a web browser, such as Internet Explorer from the company Microsoft Inc., or others.

In the context of his profession, the user can thus be directed to browse through several complex applications. On each of the applications, the user must often call up several pages before arriving at the information he is interested in. If the process has to be repeated several tens of times per day, this browsing from page to page can lead to significant time losses. In the same manner, in a complex browsing operation which is carried out rarely and with which the user is therefore not familiar, he may make errors or become lost in the application, again requiring correction or searching methods which cause time to be lost.

The object of the invention is therefore to provide the user with simple and reliable browsing through complex applications, thus allowing him to become more productive.

### SUMMARY OF THE INVENTION

The subject-matter of the invention is therefore a method for automatic browsing from a web browser over a plurality of web pages which are stored on servers so that all the data flows between the browser and the servers of the web pages pass via an interposition server, characterised in that it comprises steps for:

a. creating at least one scenario for automatic browsing comprising a web page address for launching the scenario and at least one web page address for redirection,

b. storing the scenario(s) created in the interposition server,

c. generating a request by the web browser to access the web page located at the address for launching a scenario,

d. intercepting the access request by means of the interposition server,

e. selecting the automatic browsing scenario comprising the launch address which corresponds to the address of the request and, in parallel,

f. transmitting the request for access to the server hosting the web page requested, then

g. intercepting the response of the host server to the request for access by means of the interposition server,

h. modifying the response into a redirection response including the redirection address defined in the scenario,

i. transmitting the modified response to the browser,

j. generating a request by the browser to access the redirection web page.

Other features of the invention are:
steps d to j are repeated for each new redirection address included in the scenario;
a plurality of scenarios are attached to a launch address and the selection of the scenario is dependent on session parameter values;
the scenario comprises conditions for stopping the scenario and/or conditions for extracting data from the response, the conditions being linked to the responses; and
the scenario is capable of receiving initial parameter values, these values being used in the interpretation of the scenario.

Another aspect of the invention is an interposition server comprising first means for communicating with a web browser and second means for communicating with web page servers so that all the data flows between the browser and the web page servers pass via the interposition server, comprising:
means for storing at least one automatic browsing scenario comprising a web page address for launching the scenario and at least one redirection address,
first means for intercepting any request from the web browser to access a web page server,
means for selecting the browsing scenarios comprising the launch address corresponding to the address of the request,
second means for intercepting the response of the web page server to the access request,
means for modifying the response into a redirection response including the redirection address defined in the selected scenario, and
means for transmitting the modified response to the browser.

Another aspect of the invention is a memory support comprising program instructions which are suitable for carrying out the method for automatic browsing when the program is carried out on a computer.

### BRIEF DESCRIPTION OF THE DRAWINGS

The invention will be better understood from a reading of the following description, given purely by way of example, and with reference to the appended drawings, in which:

FIG. 1 is a schematic view of an internet network having an interposition server;

FIG. 2 is a schematic view of the flow between a browser and a web server through an interposition server;

FIG. 3 is a flow chart of an embodiment of the invention, and

FIG. 4 is a schematic view of an interposition server.

### DETAILED DESCRIPTION

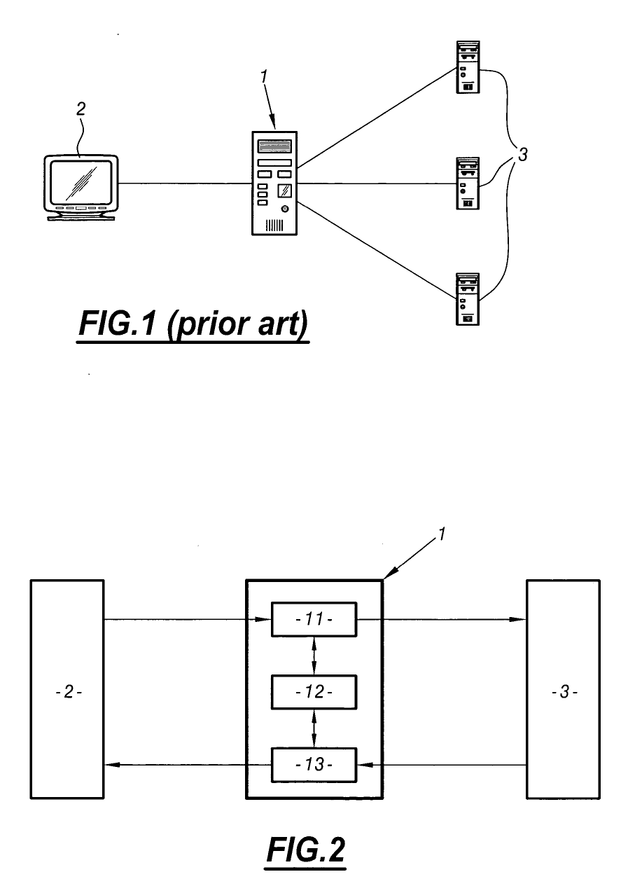

With reference to FIG. 1, a network comprises an interposition server 1 between a web browser 2 and the web page servers 3.

An interposition server is a server through which all the data flows between the browser(s) and the web servers pass.

There are numerous types of interposition server which differ in terms of their functionality. For example, a firewall is a unit which acts on all the traffic passing between two networks and protects one of them, or a portion of one of them, against any unauthorised access. The protected network is often a local network which the firewall protects from the public internet network. A work station which is located on the local network and which wishes to access the web server of the public network has all its communications filtered by the firewall.

Another example of an interposition server which is particularly relevant to this description relates to stateful interposition servers, one example of which is described in patent application WO 01/11821 filed on 7^{th} Aug. 2000. This type of interposition server allows a browser session to be created and therefore, potentially, actions to be linked in accordance with the browsing history. Each session comprises session-specific parameters, such as, for example, the value of cookies.

An interposition server of this type (FIG. 2) comprises a filter 11 for the requests originating from the web browser 2 intended for the web servers 3. This filter 11 is connected to means 12 for processing these requests. In the same manner, the web pages returned by the web server 3 pass through a second filter 13 which is also connected to the processing means 12 before being directed towards the web browser 2.

The use of cookies allows the interposition server to connect each request to the previous requests originating from the same browser and/or the same user, thus creating a browsing session for this browser.

The requests and the responses which pass via the interposition server comply with the HTTP 1.1 protocol which is described in RFC 2616 and which is available at the address http://www.ietf.org/rfc/rfc2616.txt.

In this protocol, return codes are sent by the web server 3 to the browser 2 in order to inform it of the results of its request. More particularly, the web server 3 uses return codes of the 200 type to indicate that the request has been carried out correctly, and return codes of the 300 type to indicate a redirection, that is to say that the web server 3 requests that the browser 2 be redirected to another address provided by this server. This has the result that the browser directs a new request to this address without the user having any particular action to carry out.

The various return codes of the 200 or 300 type are described in chapters 10.2 and 10.3 of RFC HTTP 1.1.

The interposition server 1 is therefore used as a support for the automatic browsing method which will be described below.

Prior to the automatic browsing operation itself, browsing scenarios are created then stored on the interposition server.

These scenarios define web page addresses for launching and web page addresses for redirection.

In a preferred embodiment, the scenarios are stored in data files whose format complies with the standard XML (Extensible Markup Language). In the same manner, the list of launch addresses and associated scenarios is stored in an XML file, such as, for example:

< ?xml version=“1.0” encoding=“UTF-8” ?>
<replay-launching-configuration>
<webreplay name=“WANADOO_MAIL”>

<startURL>http://secure.wanadoo.fr/auth_user/bin/auth_u.cgi ?se=co

</startURL>

<scenario>

<surfFile>scenarios/wanadoo.xml</surfFile>

</scenario>
</webreplay>
<webreplay name=“MODULE_COMMAND”>

<startURL>http://command.intranet.boulonsa.fr/access_database.jsp

</ startURL>

<scenario>

<surfFile>scenarios/command-intranet.xml</surfFile>

</scenario>

</webreplay>
</replay-launching-configuration>

Each scenario is thus written in a file whose name is defined by the tag <surfFile> and is launched by the address described by the tag <startURL>. The whole is placed in parentheses and designated by a tag <webreplay>.

A scenario file defined by the tag <surfFile> is, for example:

< ?xml version=″1.0″ encoding=″UTF-8″ standalone=″yes″?>
<httprecord>

<requests>

<request proxyHost=″127.0.0.1″ proxyPort=″1984″>

<method>post</method>
<protocol>http</protocol>
<host>secure.wanadoo.fr</host>
<port>80</port>
<path>/auth_user/bin/auth_user.cgi</path>
<timeout>0</timeout>
<formfield name=”service” value=”communicate”/>
<response>

<validation>

<match expression=”function display_home page( )”/>

</validation>

</response>

</request>
<request proxyHost=″127.0.0.1″ proxyPort=″1984″>

<method>get</method>
<protocol>http</protocol>
<host>r.wanadoo.fr</host>
<port>80</port>
<path>/r/Wlistemsg </path>
<timeout>0</timeout>
<response>

<validation>

<match expression=”/wanadoo/connection_submit.html;js

essionid”/>

</validation>
<extraction>

<parameter>

<name>WANADOO_JSESSIONID</name>
<expression>

/wanadoo/connection_submit.htlm;jsessionid=([\hat{ }\?]+)?

<expression>
<group>1</group>

</parameter>

</extraction>

</response>

</request>
<request proxyHost=”127.0.0.1” proxyPort=”1984”>

<method>get</method>
<protocol>http</protocol>
<host>_BRMPARAM_WRP-LAST

SERVER_ERMPARAM_</host>

<port>80</port>
<path>

/wanadoo/connection_submit.html;\\

</path>
<timeout>0</timeout>
<response>

<validation>

<match expression=

“You have &#60;b&#62;([0-9]+)&#60;/b&#62;

message“/>

</validation>

</response>

</request>

</requests>

</httprecord>

In this scenario example, written in XML, all the redirection addresses are grouped by a tag <requests>. Within this tag, reading is carried out sequentially. Each redirection address is defined by a tag <request> which comprises two large portions. The first portion, which generally begins with the tag <method> and ends with the beginning of the tag <response>, defines all the necessary fields for correctly forming the redirection address. The second portion is parenthesised by the tag <response> and defines the actions which the interposition server must carry out when it receives the response corresponding to the preceding request from the web server 3. Typically, these actions are of two types. Firstly, the validation actions defined by the tag <validation> which correspond to verification that specific character fields are actually in the response. As illustrated by the third request of the example, the validation actions use the technology of “regular expressions” which are well known to the person skilled in the art for defining models of character chains. The second type of response action relates to the parameter extractions, defined by the tag <extraction>.

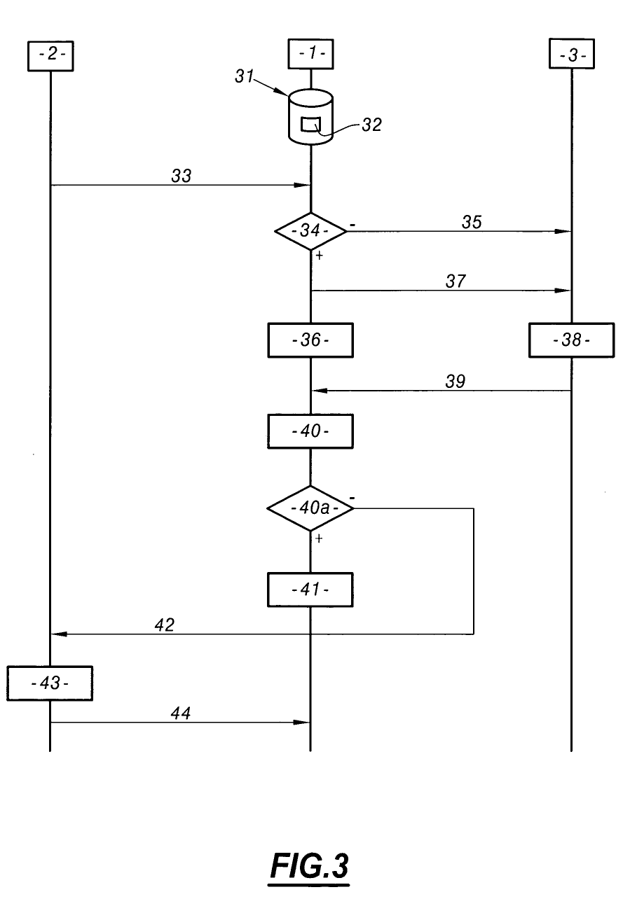

With reference to FIG. 3, the scenarios are therefore created at 31, then stored at 32 on the interposition server 1. It should be noted that the creation may be carried out on any work station. In this case, the scenario file is transferred to the interposition server 1 before being stored at that location.

The web browser 2 transmits a request at 33 in the direction of a page of a web server 3.

At 34, the interposition server 1 intercepts this request and compares the address of the web page with the addresses contained in the list of launch addresses.

If this address is not a launch address, the request is sent at 35 to the server concerned with no further processing.

If it is a launch address, however, the corresponding scenario is selected at 36 and, in parallel, the request is sent to the web server at 37.

The web server processes the request at 38 and sends a response to the browser at 39.

This response is intercepted at 40 by the interposition server.

The server verifies at 40a that this response corresponds to the response anticipated by the scenario by using the validation actions of the tag <validation>.

If the response is not the anticipated response, it is transferred to the browser 2 with no further processing.

If the response is that anticipated, and using the address fields described in the selected scenario, the server modifies the response at 41 in order to convert it into a redirection response including the redirection address extracted from the scenario, that is to say, the response is modified in order to include a response code of the 300 type.

More particularly, the response code used is one of the codes 301, 302, 303 or 307. Preferably, the code 302 is used.

This modified response is sent at 42 to the browser which automatically generates at 43 a new request with the redirection address. This is sent at 44 to the interposition server and the cycle continues until the scenario has been completed, that is to say, until the execution of the last redirection request contained in the file of the scenario.

Thus, by repeating steps 34 to 44 as the scenario file is read, an automated, complex browsing operation is advantageously constructed.

According to the operating method of the interposition server described above, together with the description of a scenario, it should be noted that the interposition server can extract values from the web pages sent in response (tag <extraction> of the scenario description files). Since these values are likened to parameters, it can readily be conceived that they can be used to complete, for example, subsequent redirection addresses present in the scenario. In this manner, the upper case parameters of the scenario example set out above represent parameters whose value has been extracted during a preceding step by means of the tags <extraction>.

In the example of a scenario file set out above, it should also be noted that, for a specific redirection page, a tag <validation> may exist. This defines a condition, generally in the form of a regular expression, which the page returned by the web server 3 must comply with. This allows stopping points of the scenario to be defined if, for example, the server returns an error page instead of the web page requested.

The extraction of data, as with the validation of pages, advantageously allows the progress of the scenario and the adaptation thereof to changing conditions to be controlled in a very precise manner.

Defining a scenario for automatic browsing in this manner allows the user to become more efficient in terms of handling complex processes, without the applications located on the web servers or the browser being modified.

In a variant of the method, it is possible to attach a plurality of scenarios to a specific launch page. The selection of the scenario is carried out by determining the value of one or more session parameters, these having been initialised during a preceding step of the session. These parameters may also act as entry parameters for the scenarios and influence the behaviour thereof. These parameters are known as “session parameters” since they are connected with all of the browsing carried out by a specific browser. As indicated above, these session parameters are preferably controlled using cookies.

This parameterisation advantageously allows the scenarios to be personalised for and adapted to a specific user since, in accordance with the parameters of his session, a particular scenario is defined and, furthermore, this scenario has parameters set, this selection being able to be different for a user requesting the same page but with different session parameters.

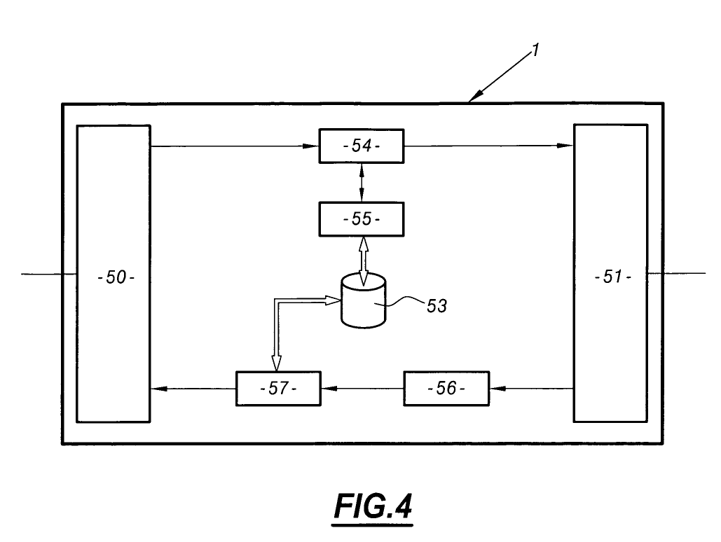

In order to carry out this method, the interposition server 1 (FIG. 4) therefore comprises means 50 for communicating with the web browser 2 and means 51 for communicating with web servers 3 so that all the data flows between the browser 2 and the web servers pass via the interposition server 1.

It also comprises means 53 for storing scenarios for automatic browsing. Each scenario comprises a web page address for launching the scenario and redirection addresses.

This interposition server has means 54 for intercepting the requests from the browser 2 to access a web server 3 and means 55 for selecting browsing scenarios so that the interception of an address of a request originating from the browser corresponding to a launch address selects the corresponding scenario.

It also comprises means 56 for intercepting the response from the web server corresponding to the request for access, which means are connected to means 57 for modifying the response into a redirection response including the redirection address defined in the selected scenarios, which means are connected to means for transmitting the modified response to the browser.

Physically, the interposition server may be a conventional computer having two network cards, one for connection to the web browser 2, and the other for connection to the web servers 3. It may also comprise only one network card. In this case, it uses its standard pieces of network control software to break down the flows, for example, by translating addresses.

A software product installed on this computer and specially developed allows the method described to be carried out on this computer. This software product can be stored on a memory support in the form of program instructions.

A method has thus been described which allows browsing over several web pages to be automated. The user thus enjoys simple and reliable browsing, even with complex applications.

1. A method for automatic browsing from a web browser over a plurality of web pages which are stored on servers so that all the data flows between the browser and the servers of the web pages pass via an interposition server, characterised in that it comprises steps for:
a. creating at least one scenario for automatic browsing comprising a web page address for launching the scenario and at least one web page address for redirection,
b. storing the scenario(s) created in the interposition server,
c. generating a request by the web browser to access the web page located at the address for launching a scenario,
d. intercepting the access request by means of the interposition server,
e. selecting the automatic browsing scenario comprising the launch address which corresponds to the address of the request and, in parallel,
f. transmitting the request for access to the server hosting the web page requested, then
g. intercepting the response of the host server to the request for access by means of the interposition server,
h. modifying the response into a redirection response including the redirection address defined in the scenario,
i. transmitting the modified response to the browser,
j. generating a request by the browser to access the redirection web page.

2. A method for automatic browsing according to claim 1, characterised in that steps d to j are repeated for each new redirection address included in the scenario.

3. A method for automatic browsing according to claim 1, characterised in that a plurality of scenarios are attached to a launch address and the selection of the scenario is dependent on session parameter values.

4. A method for automatic browsing according to claim 1, characterised in that the scenario comprises conditions for stopping the scenario and/or conditions for extracting data from the response, the conditions being linked to the responses.

5. A method for automatic browsing according to claim 1, characterised in that the scenario is capable of receiving initial parameter values, these values being used in the interpretation of the scenario.

6. An interposition server comprising first means for communicating with a web browser and second means for communicating with web page servers so that all the data flows between the browser and the web page servers pass via the interposition server, characterised in that it comprises:
means for storing at least one automatic browsing scenario comprising a web page address for launching the scenario and at least one redirection address,
first means for intercepting any request from the web browser to access a web page server,
means for selecting the browsing scenarios comprising the launch address corresponding to the address of the request,
second means for intercepting the response of the web page server to the access request,
means for modifying the response into a redirection response including the redirection address defined in the selected scenario, and
means for transmitting the modified response to the browser.

7. A memory support comprising program instructions which are suitable for carrying out the method for automatic browsing according to claim 1 any when the program is carried out on a computer.
